(19) United States
(12) Patent Application Publication
(10) Pub. No.: US 2008/0270908 A1
(43) Pub. Date: Oct. 30, 2008

(54) Systems And Methods For Contacting An Acquaintance

(76) Inventors: David Hope, Laguna Beach, CA (US); Nicola May Smart, Laguna Beach, CA (US)

Correspondence Address: HELLER EHRMAN LLP, 4350 LA JOLLA VILLAGE DRIVE #700, 7TH FLOOR, SAN DIEGO, CA, 92122, US

(21) Appl. No.: 12/109,665

(22) Filed: Apr. 25, 2008

Related U.S. Application Data
(60) Provisional application No. 60/914,276, filed on Apr. 26, 2007.

(51) Int. Cl. G06F 3/00

(52) U.S. Cl. 715/733

(57) ABSTRACT

Systems and methods are disclosed enabling users to post searchable data, such as information about themselves and others as well as details of a personal encounter such as the date, time and place where it occurred, to a user interface in a computer network. Search and match quality tools generate possible encounter matches based on comparisons of the information posted by a first and second user and provide potential matches ranked by quality of the match. Accordingly, the system and methods provide a place where people can post information about previous encounters (or proposed future encounters), lost contacts, and the like and to contact the potential encounter subject. This Abstract is provided for the sole purpose of allowing a reader to quickly ascertain the subject matter of the disclosure contained herein and should not be used to interpret or to limit the scope or meaning of the claims.

### BACKGROUND

### 1. Field of the Inventions

The field of the invention relates generally to systems and methods that provide means for establishing contact between casual acquaintances, and more particularly to a social networking environment and structure that facilitates two casually acquainted and willing parties establishing communications utilizing circumstantial information relating to a previous or anticipated encounter.

The Internet has enabled a surge of activity in social networking. Since the first recognized Internet social network (ISN), Classmates.com, appeared in 1995 there has been a proliferation of Websites serving various user needs and interests. Most ISN's employ either Old Boy Network, Web of Contacts, Circle of Trust, or Circle of Friends, or Friendster's patented Web of Friends model (U.S. Pat. No. 7,069,308). It is estimated that there are now over 200 ISN sites using these existing and emerging social networking models.

Some of these ISN's, such as “MySpace” (www.myspace.com) are designed to allow users and members to connect online with people they already know and have a relationship with in the “real world”, or with people they have only met online. Other sites, such as “Friends Reunited” (www.friendsreunited.com) and “Classmates.com” are designed to help users reestablish contact with people they went to school with, or to college with, or worked at a particular business or corporation with. These sites are therefore designed to help users find long lost friends that attended some permanent institution that they themselves also attended. While people may use sites like MySpace to arrange to meet with people they already know, or people they have met online, these sites are not specifically or efficiently designed to help a user find and meet people they have just met, seen, bumped into, or simply made eye contact with in the real world. More importantly, these sites have no search functionality that allows users to do this effectively.

Thus, there remains a need for an ISN that is directed to providing a more convenient and efficient means for establishing contact between individuals. The need for such a service is evidenced by the popularity of the “Lost Contacts” feature in Craig's List (http://sfbay.craigslist.org). While directed primarily to the goal of connecting individuals that may have had casual contact in the real world, but lack the information necessary to pursue the relationship further, this Craig's List feature lacks any automated search capabilities and therefore depends on the patience and diligence of the users for success.

### SUMMARY OF THE INVENTION

KontactMe (www.KontactMe.com) is a social networking Website and related business that helps people reconnect with people they have just met, seen, bumped into, or simply made eye contact with. It could be someone recently met, but did not get or simply forgot to get their phone number or email address. Or, it could be someone observed at a social or business function, but were unable to speak with and get their contact information. Many circumstances may arise where people find themselves wishing they were able to connect with another individual, but only have circumstantial information pertaining to that person and the encounter. In such a case, the individual seeking the contact can post what information they have relative to the person they are seeking on the KontactMe Website and hope for a response. More generally, KontactMe allows people to post any information about themselves and others as well as details such as the date, time, and place of any location they were at, that allows others to easily and quickly find them. Thus, KontactMe provides the ability to contact not only specific individuals, but Members of a group that were encountered, for example in a particular social or business context. In addition, KontactMe allows people to search the postings of others by a similar wide range of criteria in order to find someone they would like to know more about.

An exemplary provided embodiment includes a method of matching users based on provided searchable data. In this embodiment a first user is provided an interactive user interface which allows the user to enter a variety of data. A second interactive interface is additionally provided at a second location. In like manner the second interface allows a user to enter a variety of data. In this embodiment, a computer system uses predetermined criteria to compare data provided by the users and generates a rank based on the quality of the match. The rank is then provided to a user interface in a manner viewable by the first or second user.

These and other features, aspects, and embodiments of the invention are described below in the section entitled “Detailed Description of the Preferred Embodiments.”

### BRIEF DESCRIPTION OF THE DRAWINGS

Features, aspects, and embodiments of the inventions are described in conjunction with the attached drawings, in which:

FIG. 1 presents an exemplary REASONS TO JOIN computer screen window displaying examples of motives for using the Website that could be presented to a visitor to the KontactMe Home Page of the KontactMe Website.

FIG. 2 presents an exemplary SIGN UP FOR MEMBERSHIP computer screen user menu window of the KontactMe Website.

FIG. 3 presents an exemplary POST SEARCHABLE DATA—LOCATION computer screen user menu window of the KontactMe Website.

FIG. 4 presents an exemplary POST SEARCHABLE DATA—DESCRIBE YOURSELF computer screen user menu window of the KontactMe Website.

FIG. 5 presents an exemplary POST SEARCHABLE DATA—DESCRIBE OTHER PARTY computer screen user menu window of the KontactMe Website.

FIG. 6 presents an exemplary POST SEARCHABLE DATA—SAY WHAT YOU WANT computer screen user menu window of the KontactMe Website.

FIG. 7 presents an exemplary POST SEARCHABLE DATA—LOOKING FOR YOU computer screen user menu window of the KontactMe Website.

### DETAILED DESCRIPTION OF THE PREFERRED EMBODIMENTS

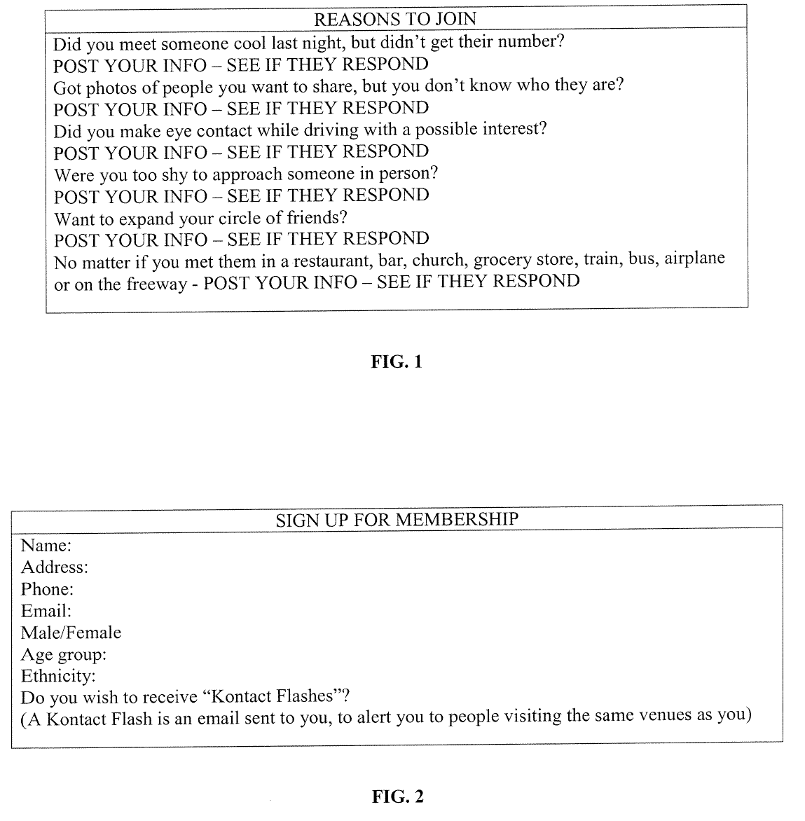

The KontactMe Home Page can contain a description of the purpose and functionality of the Website. More specifically, it may include a list of motives for using the site, such as those exemplified in FIG. 1. Additionally, the Home Page may present a navigation menu with icons having descriptions and associated links that may include options such as MAKE A POST, SEARCH A SITE, SPECIAL AREAS, LEGALITIES, etc. The Home Page and other pages of the KontactMe Website are intended for interactive access by individual computers connected to the Internet and World Wide Web or similar computer accessible network. The KontactMe Website comprises a computer system, as is well known in the art, that serves informational content over a network using the standard protocols of the World Wide Web.

The KontactMe Website may include functionality that allows a user to conveniently post information about themselves and those they are interested in contacting. A graphical user interface with menus and links to other related pages, as is typically found on Internet Web pages, may be provided on a MAKE A POST page. Links to the MAKE A POST page may be provided from the Home Page and from other convenient locations within the KontactMe Website domain. It is contemplated that posting of information on the Website would be preferably limited to Members, but that membership would be free. An exemplary SIGN UP FOR MEMBERSHIP user registration menu window is depicted in FIG. 2, to which links may be provided on the Home Page as well as from other pages, windows, or frames throughout the entire Website domain. The information required for membership may include some basic required information, such as name and Email address, while other information such as age, gender, ethnicity, etc. could be optional, but encouraged so as to help facilitate correct identification. For convenience, a unique user identification (ID) can be assigned to each user.

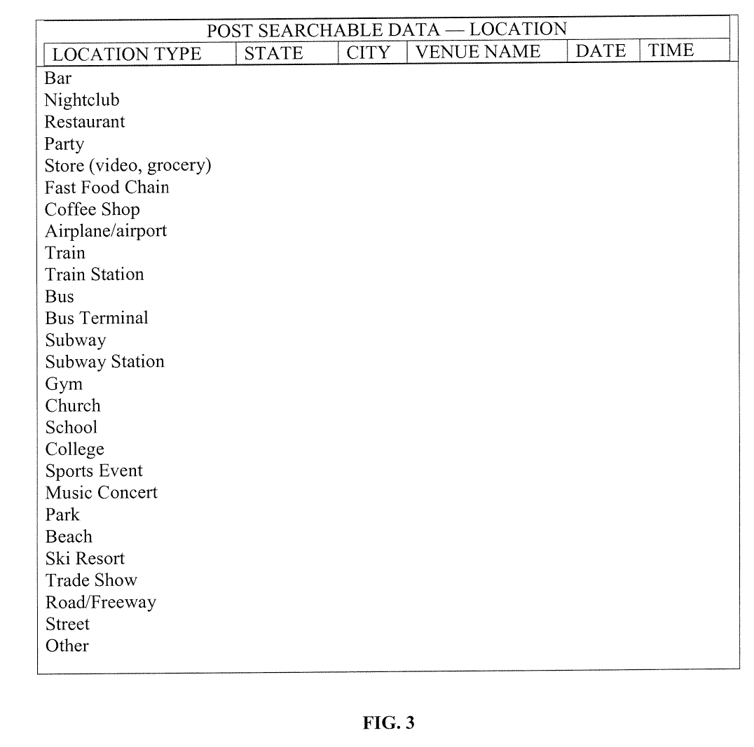

The MAKE A POST Webpages may also advantageously include a POST SEARCHABLE DATA—LOCATION page presenting a table of searchable location and temporal data, similar to that depicted in FIG. 3. This Webpage would provide the Member User an opportunity to enter information pertaining to the circumstance of the encounter for which they want to establish or reestablish contact. A menu of choices could include various common venue categories such as Bar, Nightclub, Restaurant, Party, etc. Each venue category may include a subcategory menu to further identify the location or time of the encounter. For example, the category “Airplane” may include a further subcategory menu that would allow the User to fill in the name of the airline, the flight number, departure and destination of the flight, etc. Likewise, selecting “Freeway” could present a menu allowing the User to enter the freeway number, direction traveled, nearest exit, etc. These data categories may advantageously include the capability of entering ranges for the various parameters. For example, the Time entry could provide for a range between, say, 2 PM and 6 PM, and the Date could even include a range of days, say between Oct. 30 and Nov. 12, 2007. Other categories could allow for corresponding quantitative or even qualitative data ranges. The purpose of these location, time, and other circumstantial data would be to help the intended contact or contacts identify the encounter the poster is referring to based on the location, time, and other circumstances of the occurrence.

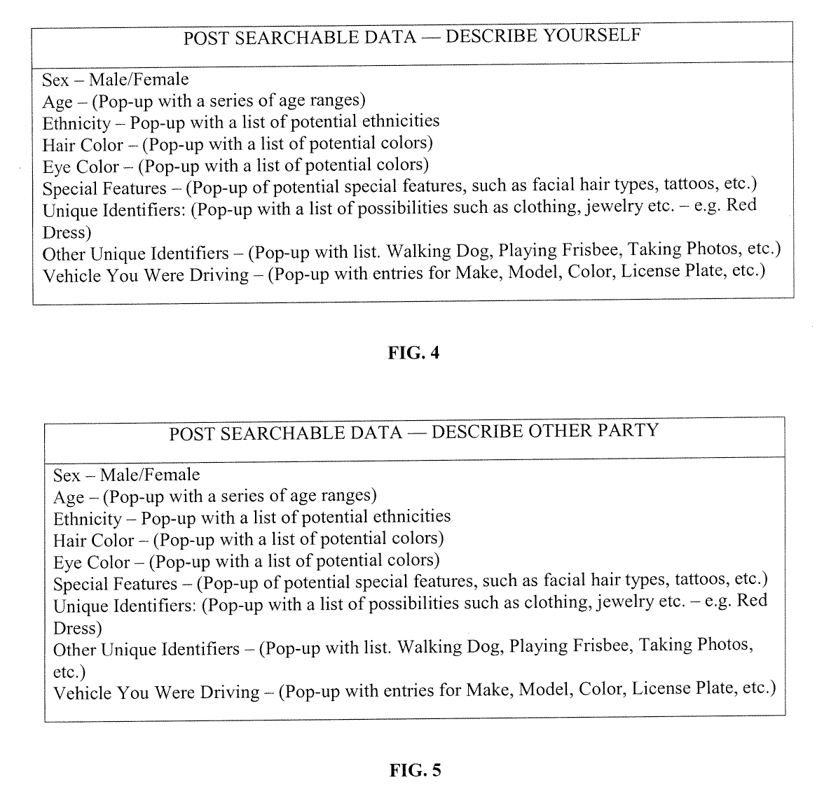

The MAKE A POST Webpages may also advantageously include a POST SEARCHABLE DATA—DESCRIBE YOURSELF page that presents a table of information categories pertaining to the poster's personal attributes, such as exemplified in FIG. 4. These data may include visually identifiable personal information such as sex, age, ethnicity, hair color, eye color, clothing worn, vehicle driven, photos, etc. The purpose of this information would be to help the intended party to correctly identify the poster.

The MAKE A POST Webpages may also advantageously include a POST SEARCHABLE DATA—DESCRIBE OTHER PARTY page that presents a table of information categories pertaining the intended contact's personal attributes. These personal attribute characteristics included on the DESCRIBE OTHER PARTY page could essentially mirror the attributes presented in the DESCRIBE YOURSELF page as exemplified in FIG. 5. The purpose of this page would be to help a potential contact recognize themselves as the intended recipient of the posting.

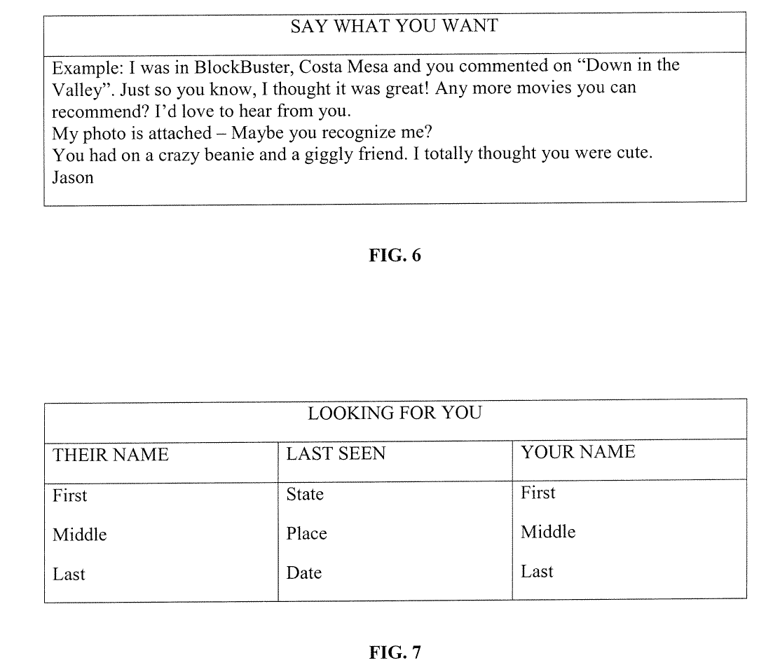

The MAKE A POST Webpages may also advantageously include a POST SEARCHABLE DATA—SAY WHAT YOU WANT page that provides the poster an opportunity to enter a narrative message to the intended contact or contacts for the purpose of further describing the circumstances of the encounter and, reactions, intentions, etc. of the poster. An exemplary SAY WHAT YOU WANT posting is presented in FIG. 6. The narrative message would advantageously be searchable to enable Boolean or similar types of searches to facilitate matching with data provided by potential contacts. Other contemplated posting capabilities include ADD PHOTOS OF YOURSELF and ADD PHOTOS OF OTHERS, these photos being subject to removal by the KontactMe Website Manager, or upon request by a third party through a REMOVAL REQUEST entry on the Website. The KontactMe Website could also include the ability for the poster to review their post prior to submission, or at a later time. Once a post is submitted, the data can remain in the database and be continuously available for searching by others until the poster chooses to remove it, the poster terminates their membership, a term limit is exceed, or for some other reason at the discretion of the Website Manager.

The MAKE A POST Webpages may also advantageously include a POST SEARCHABLE DATA—LOOKING FOR YOU page that allows posting of information pertaining to an individual the poster has lost contact with. An exemplary menu of information categories presented on the LOOKING FOR YOU page is presented in FIG. 7. Other information categories may be added to this and other menus described above as is well known to those familiar with Website design and particularly ISN Website design.

One of the useful functions provided by the KontactMe Website is the ability to conduct searches of posted data across all posters and to generate possible matches. The search results will advantageously rank the quality of the matches based on several criteria as described more fully below. One exemplary search matching criterion could be the LOCATION and DATE of the encounter. The KontactMe site could search all postings to find other posts having the same or similar locations and/or dates of encounter. Another exemplary search matching criterion could be a match based on the similarities between the DESCRIBE YOURSELF data of a poster and the DESCRIBE OTHER PARTY data of all other posters. Similarly, the KontactMe Website can perform a complementary search comparing a poster's DESCRIBE OTHER PARTY data with the DESCRIBE YOURSELF data of all other posters. Search results can be presented to the User in summary format and ranked by quality or degree of the match. The search results will advantageously need to meet some minimum quality standard for inclusion on the list. Various methods for carrying out database searches and ranking matches in terms of quality are known and will be recognized by those who practice the art. Links from each search result to the information for that poster can be conveniently included to allow the User to review the match for further details.

If, after reviewing a potential contact match, the User wishes to communicate, an Email may be forwarded to the potential contact Member through a “double-blind” anonymous method. Such methods for achieving anonymity or “double-blind” communications between Users are well known and practiced in networking environments in general and in regard to social networking services in particular. By this means, a Member has full discretion as to whether to respond, and if responding, whether through the KontactMe Website's anonymous communication channel or directly with the requesting Member by exchange of contact information such as Email address, telephone number, suggested meeting place, etc.

The KontactMe Website may also allow restricted searches by non-members. For example, although a non-member may make a POST, they may only be permitted to make one-time searches based on a limited data input; for example only LOCATION and DESCRIBE OTHER PARTY data may be permitted for KontactMe non-members. In such a case, the KontactMe Website could conduct a search and present results for any Member posting having similar LOCATION and DATE together with the match results comparing the non-member DESCRIBE OTHER PARTY data with DESCRIBE YOURSELF Member data. As with Member/Member searches, search results can be presented in summary form and ranked according to match quality with links to the respective Member information pages. However, before a non-member may contact any of the potential search matches, they first must become a Member. Upon a request by a non-member to contact a Member, a link to the MEMBERSHIP Webpage may be conveniently provided.

KontactMe search capabilities may further include the ability to automatically send an acknowledgement and some details of any new posting or search to any Member for which a match having a minimum quality level was reported. Members can be notified of their inclusion in search results by Email and/or by a notice in the Member's MY ACCOUNT section of the KontactMe Website.

In order to provide even further utility to its Members, the KontactMe Website may also include CIRCLE OF FRIENDS searches. This category of search would be directed to other Members who may wish to share some common activity, either past or future. For example: who else went to a particular club or restaurant last Friday; who is going to be on the same plane to New York next week; or who will be at (or were at) a concert you will (or did) attend? Similar to the other category menus described above, a CIRCLE OF FRIENDS posting page can include a menu that includes categories similar to, or even subsumed by, the POST SEARCHABLE DATA—LOCATION Webpage.

The KontactMe Website may include additional features to provide an even more comprehensive service. These services may include, without limitation, a Chat Room where people can interact in quasi-real time, a Photo of the Week, a KontactMe Events calendar, a My Favorite Hang directory where members can submit their favorite places to hang out, a KontactMe Success Stories page that allows Members to submit personal stories they wish to share, and other such categories in this spirit.

While certain embodiments of the inventions have been described above, it will be understood that the embodiments described are by way of example only. Accordingly, the inventions should not be limited based on the described embodiments. Rather, the scope of the inventions described herein should only be limited in light of the claims that follow when taken in conjunction with the above description and accompanying drawings.

What is claimed:

1. In a computer system including a server and a database of registered users, a method comprising the steps of:
providing for viewing at a first location, a first interactive user interface adapted for entry of searchable data, whereby a first user enters a plurality of first searchable data; and,
providing for viewing at a second location, a second interactive interface, whereby a second user enters a plurality of second searchable data;
comparing by the computer system the searchable data of the first and second users using predetermined criteria to generate a rank according to a quality of the data match; and,
presenting one of the first or second user with the rank of the data match.

2. The method of claim 1, wherein one of the first or second users is a registered user.

3. The method of claim 1, wherein the searchable data comprises at least one member of the group consisting of: a date, a time, and a location of a possible encounter between the first and second user.

4. The method of claim 1, wherein the searchable data comprises categories of searchable data relating to a possible encounter between the first and second user.

5. The method of claim 4, wherein the categories of searchable data comprises at least one member of the group consisting of: a restaurant, a nightclub, a bar, a freeway, a highway, an airline, a club, and a party.

6. The method of claim 2, wherein the computer system provides one of the users information relating to contacting the registered user.

7. The method of claim 6, wherein contacting the registered user is performed through an anonymous double-blind channel.

8. The method of claim 7, wherein the anonymous double-blind channel is a double-blind email address.

9. The method of claim 6, wherein the information relating to contacting is selected from a group consisting of: an email address, a telephone number, and a meeting location.

10. The method of claim 1, wherein the searchable data includes at least one range of values.

11. The method of claim 1, wherein the rank is given a value that indicates how closely one or more of the corresponding searchable data values of the two users match.

12. The method of claim 11, wherein the rank is based at least in part on the geographic proximity of the location data provided by the first and second users.

13. The method of claim 11, wherein the rank is based at least in part on the temporal proximity of the date or time provided by the first and second users.

14. The method of claim 3, wherein the date or time is a future date or time.

15. The method of claim 1, wherein the searchable data comprises information relating to personal appearance.

16. The method of claim 15, wherein the information relating to personal appearance comprises at least one member of the group consisting of: a sex, an age, an ethnicity, a hair color, an eye color, an article of clothing worn, and a vehicle driven.

17. The method of claim 15 wherein the information relating to personal appearance relates to the user's own personal appearance.

18. The method of claim 15 wherein the information relating to personal appearance relates to another user's personal appearance.

19. A computing apparatus comprising:
a processor;
a memory communicating with the processor; and
a storage media communicating with the processor and the memory, the storage media comprising a set of processor executable instructions that, when executed by the processor, configure the computing apparatus to generate a match report, the configuration comprising a configuration to:
provide a first interactive interface at a first location, the first interactive interface adapted for entry of searchable data by a first user;
provide a second interactive interface at a second location, the second interactive interface adapted for entry of searchable data by a second user;
receiving from the first and second locations the searchable data;
comparing the searchable data from the first location to the searchable data from the second location;
generating a rank based on the comparison; and
providing the rank to the first or the second locations.

20. The apparatus of claim 19, wherein one of the first or second users is a registered user.

21. The apparatus of claim 19, wherein the searchable data comprises at least one member of the group consisting of: a date, a time, and a location of a possible encounter between the first and second user.

22. The apparatus of claim 19, wherein the searchable data comprises categories of searchable data relating to a possible encounter between the first and second user.

23. The apparatus of claim 22, wherein the categories of searchable data comprises at least one member of the group consisting of: a restaurant, a nightclub, a bar, a freeway, a highway, an airline, a club, and a party.

24. The apparatus of claim 20, wherein the computer system provides one of the users information relating to contacting the registered user.

25. The apparatus of claim 24, wherein contacting the registered user is performed through an anonymous double-blind channel.

26. The apparatus of claim 25, wherein the anonymous double-blind channel is a double-blind email address.

27. The apparatus of claim 25, wherein the information relating to contacting is selected from a group consisting of: an email address, a telephone number, and a meeting location.

28. The apparatus of claim 19, wherein the searchable data includes at least one range of values.

29. The apparatus of claim 19, wherein the rank is given a value that indicates how closely one or more of the corresponding searchable data values of the two users match.

30. The apparatus of claim 29, wherein the rank is based at least in part on the geographic proximity of the location data provided by the first and second users.

31. The method of claim 29, wherein the rank is based at least in part on the temporal proximity of the date or time provided by the first and second users.

32. The method of claim 31, wherein the date or time is a future date or time.

33. The method of claim 19, wherein the searchable data comprises information relating to personal appearance.

34. The method of claim 33, wherein the information relating to personal appearance comprises at least one member of the group consisting of: a sex, an age, an ethnicity, a hair color, an eye color, an article of clothing worn, and a vehicle driven.

35. The method of claim 33 wherein the information relating to personal appearance relates to the user's own personal appearance.

36. The method of claim 33 wherein the information relating to personal appearance relates to another user's personal appearance.
